(19) United States
(12) Patent Application Publication
(10) Pub. No.: US 2023/0010158 A1
(43) Pub. Date: Jan. 12, 2023

(54) HYDROGEN POWERED GEARED TURBOFAN ENGINE WITH REDUCED SIZE CORE ENGINE

(71) Applicant: Raytheon Technologies Corporation, Farmington, CT (US)

(72) Inventors: Marc J. Muldoon, Marlborough, CT (US); Joseph B. Staubach, Colchester, CT (US); Charles E. Lents, Amston, CT (US)

(21) Appl. No.: 17/860,742

(22) Filed: Jul. 8, 2022

Related U.S. Application Data
(60) Provisional application No. 63/220,107, filed on Jul. 9, 2021.

(51) Int. Cl. F02C 9/40; B64D 37/30; B64D 37/34; F02C 3/22

(52) U.S. Cl. CPC F02C 9/40; B64D 37/30; B64D 37/34; F02C 3/22; B64D 2041/005

(57) ABSTRACT

A turbine engine system includes aircraft systems including at least one hydrogen fuel tank, engine systems comprising a compressor section, a combustor section having a burner, and a turbine section, and a hydrogen fuel flow supply line configured to supply hydrogen fuel from the at least one hydrogen fuel tank into the burner for combustion. The turbine engine system has a bypass ratio between 5 to 20.

### CROSS-REFERENCE TO RELATED APPLICATIONS

This application claims the benefit of U.S. Provisional Application No. 63/220,107 filed Jul. 9, 2021, the disclosure of which is incorporated herein by reference in its entirety.

### BACKGROUND

The present disclosure relates generally to turbine engines and aircraft engines, and more specifically to employing hydrogen fuel systems and related systems with turbine and aircraft engines.

Gas turbine engines, such as those utilized in commercial and military aircraft, include a compressor section that compresses air, a combustor section in which the compressed air is mixed with a fuel and ignited, and a turbine section across which the resultant combustion products are expanded. The expansion of the combustion products drives the turbine section to rotate. As the turbine section is connected to the compressor section via a shaft, the rotation of the turbine section drives the compressor section to rotate. In some configurations, a fan is also connected to the shaft and is driven to rotate via rotation of the turbine.

Typically, liquid fuel is employed for combustion onboard an aircraft, in the gas turbine engine. The liquid fuel has conventionally been a hydrocarbon-based fuel. Alternative fuels have been considered, but suffer from various challenges for implementation, particularly on aircraft. Hydrogen-based and/or methane-based fuels are viable effective alternatives which may not generate the same combustion byproducts as conventional hydrocarbon-based fuels. The use of hydrogen and/or methane, as a gas turbine fuel source, may require very high efficiency propulsion, in order to keep the volume of the fuel low enough to feasibly carry on an aircraft. That is, because of the added weight associated with such liquid/compressed/supercritical fuels, such as related to vessels/containers and the amount (volume) of fuel required, improved efficiencies associated with operation of the gas turbine engine may be necessary.

### BRIEF DESCRIPTION

According to one embodiment, a turbine engine system is provided. The turbine engine system includes aircraft systems including at least one hydrogen fuel tank, engine systems including a compressor section, a combustor section having a burner, and a turbine section, and a hydrogen fuel flow supply line configured to supply hydrogen fuel from the at least one hydrogen fuel tank into the burner for combustion. The turbine engine system has a bypass ratio between 5 to 20.

In addition to one or more of the features described above, or as an alternative, further embodiments may include that the bypass ratio is between 5 to 18.

In addition to one or more of the features described above, or as an alternative, further embodiments may include that the bypass ratio is between 5 to 15.

In addition to one or more of the features described above, or as an alternative, further embodiments may include that the bypass ratio is between 5 to 13.

In addition to one or more of the features described above, or as an alternative, further embodiments may include that the bypass ratio is between 5 to 9.

In addition to one or more of the features described above, or as an alternative, further embodiments may include that the turbine engine system has a core size of 4.5 lbm/s.

In addition to one or more of the features described above, or as an alternative, further embodiments may include that the engine systems further include a fan, wherein the fan has a fan diameter of about 215.65 centimeters (84.9 inches).

In addition to one or more of the features described above, or as an alternative, further embodiments may include that the aircraft systems further include a first heat exchanger. The engine system further include at least a second heat exchanger and a third heat exchanger. The hydrogen fuel is supplied from the at least one hydrogen fuel tank through the hydrogen fuel flow supply line, passing through the first heat exchanger of the aircraft systems, the second heat exchanger of the engine systems, and the third heat exchanger of the engine systems, and then supplied into the burner for combustion.

In addition to one or more of the features described above, or as an alternative, further embodiments may include that the first heat exchanger is a hydrogen fuel-to-air heat exchanger.

In addition to one or more of the features described above, or as an alternative, further embodiments may include that the first heat exchanger is part of a cabin air conditioning system of an aircraft.

In addition to one or more of the features described above, or as an alternative, further embodiments may include that the second heat exchanger is a hydrogen fuel-to-oil heat exchanger.

In addition to one or more of the features described above, or as an alternative, further embodiments may include that the third heat exchanger is a hydrogen fuel-to-air heat exchanger.

In addition to one or more of the features described above, or as an alternative, further embodiments may include that the aircraft systems include an auxiliary power source configured to receive the hydrogen fuel from the at least one hydrogen fuel tank to generate power.

In addition to one or more of the features described above, or as an alternative, further embodiments may include that the auxiliary power source is a fuel cell.

In addition to one or more of the features described above, or as an alternative, further embodiments may include that the auxiliary power source is a thermal engine with a burner for combusting the hydrogen fuel to generate power.

In addition to one or more of the features described above, or as an alternative, further embodiments may include that the auxiliary power source is connected to a generator to generate electric power onboard an aircraft.

In addition to one or more of the features described above, or as an alternative, further embodiments may include at least one pump arranged along the hydrogen fuel flow supply line between the at least one hydrogen fuel tank and the first heat exchanger.

In addition to one or more of the features described above, or as an alternative, further embodiments may include at least one pump arranged along the hydrogen fuel flow supply line between the first heat exchanger and the second heat exchanger.

In addition to one or more of the features described above, or as an alternative, further embodiments may include a valve arranged along the hydrogen fuel flow supply line between the third heat exchanger and the burner, the valve configured to control a flow of the hydrogen fuel into the burner.

According to some embodiments, turbine engine systems are provided. The turbine engine systems include aircraft systems comprising at least one hydrogen fuel tank, engine systems comprising a compressor section, a combustor section having a burner, and a turbine section, and a hydrogen fuel flow supply line configured to supply hydrogen fuel from the at least one hydrogen fuel tank into the burner for combustion. The turbine engine system has a bypass ratio of under 20 and above 12.

In addition to one or more of the features described above, or as an alternative, further embodiments, the turbine engine systems may include that the bypass ratio is under 18 and above 12.

In addition to one or more of the features described above, or as an alternative, further embodiments, the turbine engine systems may include that the bypass ratio is under 15 and above 12.

In addition to one or more of the features described above, or as an alternative, further embodiments, the turbine engine systems may include that the bypass ratio is about 13.

In addition to one or more of the features described above, or as an alternative, further embodiments, the turbine engine systems may include that the turbine engine system has a core size of size of 1.5 to 4.5 lbm/s.

In addition to one or more of the features described above, or as an alternative, further embodiments, the turbine engine systems may include that the turbine engine system has a core size of size of 4.5 lbm/s.

In addition to one or more of the features described above, or as an alternative, further embodiments, the turbine engine systems may include that the engine systems further comprise a fan, wherein the fan has a fan diameter of between 210 cm and 220 cm (82 inches to 86 inches).

In addition to one or more of the features described above, or as an alternative, further embodiments, the turbine engine systems may include that the engine systems further comprise a fan, wherein an engine core size to fan diameter ratio at max climb is between 0.003 and 0.010 kg/s·cm (between 0.017 and 0.053 lbm/sin)

In addition to one or more of the features described above, or as an alternative, further embodiments, the turbine engine systems may include that the aircraft systems further comprise a first heat exchanger, wherein the engine system further comprise at least a second heat exchanger and a third heat exchanger, and wherein the hydrogen fuel is supplied from the at least one hydrogen fuel tank through the hydrogen fuel flow supply line, passing through the first heat exchanger of the aircraft systems, the second heat exchanger of the engine systems, and the third heat exchanger of the engine systems, and then supplied into the burner for combustion.

In addition to one or more of the features described above, or as an alternative, further embodiments, the turbine engine systems may include that the first heat exchanger is a hydrogen fuel-to-air heat exchanger.

In addition to one or more of the features described above, or as an alternative, further embodiments, the turbine engine systems may include that the first heat exchanger is part of a cabin air conditioning system of an aircraft.

In addition to one or more of the features described above, or as an alternative, further embodiments, the turbine engine systems may include that the second heat exchanger is a hydrogen fuel-to-oil heat exchanger.

In addition to one or more of the features described above, or as an alternative, further embodiments, the turbine engine systems may include that the third heat exchanger is a hydrogen fuel-to-air heat exchanger.

In addition to one or more of the features described above, or as an alternative, further embodiments, the turbine engine systems may include that the aircraft systems include an auxiliary power source configured to receive the hydrogen fuel from the at least one hydrogen fuel tank to generate power.

In addition to one or more of the features described above, or as an alternative, further embodiments, the turbine engine systems may include that the auxiliary power source is a fuel cell.

In addition to one or more of the features described above, or as an alternative, further embodiments, the turbine engine systems may include that the auxiliary power source is a thermal engine with a burner for combusting the hydrogen fuel to generate power.

In addition to one or more of the features described above, or as an alternative, further embodiments, the turbine engine systems may include that the auxiliary power source is connected to a generator to generate electric power onboard an aircraft.

In addition to one or more of the features described above, or as an alternative, further embodiments, the turbine engine systems may include at least one pump arranged along the hydrogen fuel flow supply line between the at least one hydrogen fuel tank and the first heat exchanger.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic cross-sectional illustration of a gas turbine engine architecture that may employ various embodiments disclosed herein;

FIG. 2 is a schematic illustration of a turbine engine system in accordance with an embodiment of the present disclosure that employs a non-hydrocarbon fuel source; and

FIG. 3 is a schematic diagram of an aircraft propulsion system in accordance with an embodiment of the present disclosure.

### DETAILED DESCRIPTION

A detailed description of one or more embodiments of the disclosed apparatus and method are presented herein by way of exemplification and not limitation with reference to the Figures.

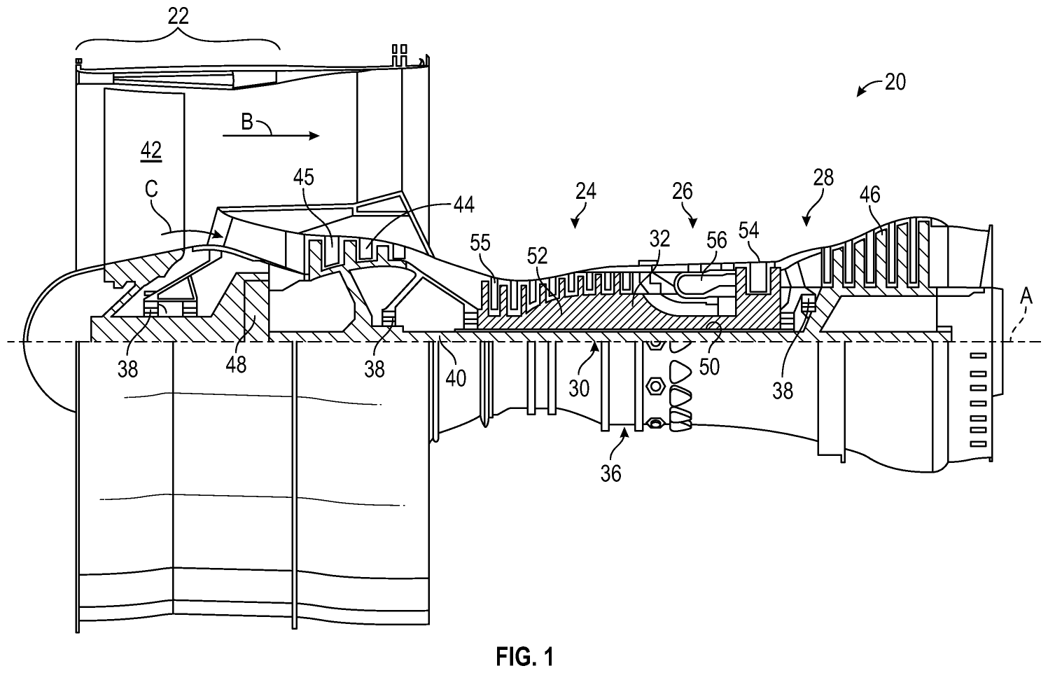

FIG. 1 schematically illustrates a gas turbine engine 20. The gas turbine engine 20 is disclosed herein as a two-spool turbofan that generally incorporates a fan section 22, a compressor section 24, a combustor section 26, and a turbine section 28. The fan section 22 drives air along a bypass flow path B in a bypass duct, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a low pressure compressor 44 and a low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a high pressure compressor 52 and high pressure turbine 54. A combustor 56 is arranged in exemplary gas turbine 20 between the high pressure compressor 52 and the high pressure turbine 54. An engine static structure 36 is arranged generally between the high pressure turbine 54 and the low pressure turbine 46. The engine static structure 36 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. In some embodiments, stator vanes 45 in the low pressure compressor 44 and stator vanes 55 in the high pressure compressor 52 may be adjustable during operation of the gas turbine engine 20 to support various operating conditions. In other embodiments, the stator vanes 45, 55 may be held in a fixed position. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (′ TSFC′)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram°R)/(518.7° R)]^{0.5}. The “Low corrected fan tip speed” as disclosed herein according to one non-limiting embodiment is less than about 1150 ft/second (350.5 m/sec).

Gas turbine engines generate substantial amounts of heat that is exhausted from the turbine section 28 into a surrounding atmosphere. This expelled exhaust heat represents wasted energy and can be a large source of inefficiency in gas turbine engines. Further, transitioning away from hydrocarbon-based engines may provide significant advantages, as described herein.

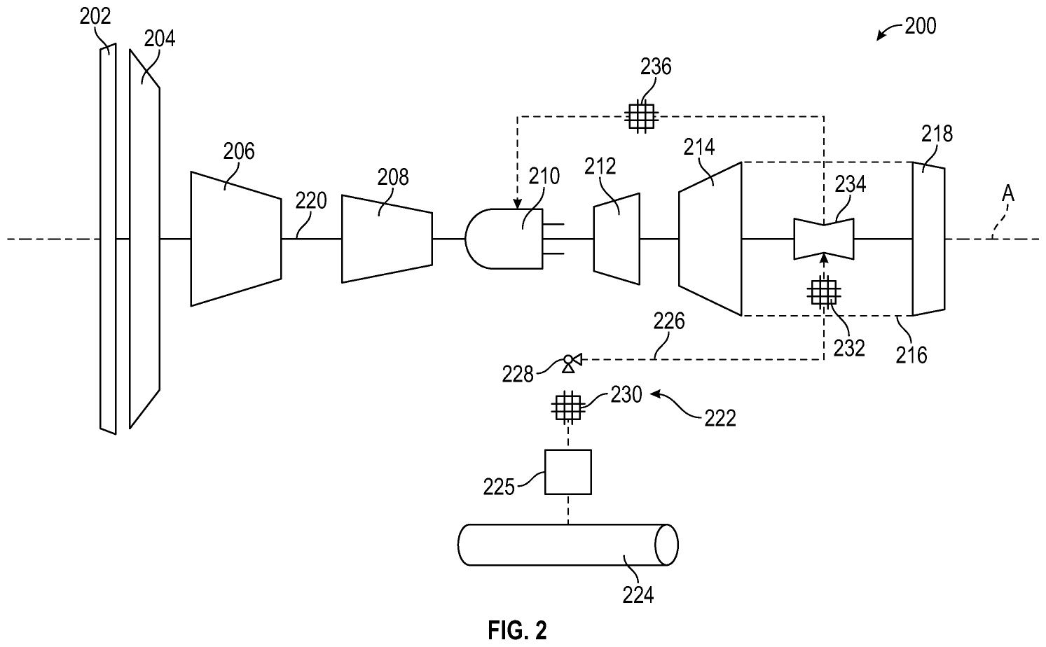

Referring now to FIG. 2, a schematic diagram of a turbine engine system 200 is illustrated, in accordance with an embodiment of the present disclosure. The turbine engine system 200 may be similar to that shown and described above but is configured to employ a non-hydrocarbon fuel source, such as hydrogen. The turbine engine system 200 includes an inlet 202, a fan 204, a low pressure compressor 206, a high pressure compressor 208, a combustor 210, a high pressure turbine 212, a low pressure turbine 214, a core nozzle 216, and an outlet 218. A core flow path is defined through, at least, the compressor 206, 208, the turbine 212, 214, and the combustor sections 210. The compressor 206, 208, the turbine 212, 214, and the fan 204 are arranged along a shaft 220. The shaft 220 is aligned along the engine central longitudinal axis A of the turbine engine system 200.

As shown, the turbine engine system 200 includes a hydrogen fuel system 222. The hydrogen fuel system 222 is configured to supply a hydrogen fuel from a hydrogen fuel tank 224 to the combustor 210 for combustion thereof. In this illustrative embodiment, the hydrogen fuel may be supplied from the hydrogen fuel tank 224 to the combustor 210 through a hydrogen fuel supply line 226. The hydrogen fuel supply line 226 may be controlled by a flow controller 228 (e.g., pump(s), valve(s), or the like). The flow controller 228 may be configured to control a flow through the hydrogen fuel supply line 226 based on various criteria as will be appreciated by those of skill in the art. For example, various control criteria can include, without limitation, target flow rates, target pressure, target hydrogen expansion turbine output, cooling demands at one or more heat exchangers, target flight envelopes, etc. The pressure of the hydrogen fuel will be increased at the flow controller 228, preferably when the hydrogen fuel is in the liquid state for low pressurization power. As shown, between the hydrogen fuel tank 224 and the flow controller 228 may be one or more heat exchangers 230, which can be configured to provide cooling to various systems onboard an aircraft by using the hydrogen fuel as a cold-sink. Such hydrogen heat exchangers 230 may be configured to warm the hydrogen and aid in a transition from a liquid state to a gaseous state for combustion within the combustor 210. As shown, between the hydrogen fuel tank 224 and the heat exchangers 230 may be one or more fluid pumps 225, which can be configured to increase the pressure of the hydrogen fuel flowing from the hydrogen fuel tank 224. The heat exchangers 230 may receive the hydrogen fuel directly from the hydrogen fuel tank 224 as a first working fluid and a component-working fluid for a different onboard system. For example, the heat exchanger 230 may be configured to provide cooling to power electronics of the turbine engine system 200 (or other aircraft power electronics). In some non-limiting embodiments, an optional secondary fluid circuit may be provided for cooling one or more aircraft loads. In this secondary fluid circuit, a secondary fluid may be configured to deliver heat from the one or more aircraft loads to a single liquid hydrogen heat exchanger. As such, heating of the hydrogen fuel and cooling of the secondary fluid may be achieved. The above described configurations and variations thereof may serve to begin raising a temperature of the hydrogen fuel to a desired temperature for efficient combustion in the combustor 210.

After the flow controller increases the pressure of the hydrogen, pumping it to high pressure as a liquid in one embodiment, the hydrogen fuel may then pass through an optional supplemental heating heat exchanger 236. The supplemental heating heat exchanger 236 may be configured to receive hydrogen fuel as a first working fluid and as the second working fluid may receive one or more aircraft system fluids, such as, without limitation, engine oil, environmental control system fluids, pneumatic off-takes, or cooled cooling air fluids. As such, the hydrogen fuel will be heated, and the other fluid may be cooled. The hydrogen fuel will then be injected into the combustor 210 through one or more hydrogen fuel injectors, as will be appreciated by those of skill in the art.

When the hydrogen fuel is directed along the hydrogen fuel supply line 226, the hydrogen fuel can pass through a core flow path heat exchanger 232 (e.g., an exhaust waste heat recovery heat exchanger) or other type of heat exchanger. The core flow path heat exchanger 232 is a hydrogen-to-air heat exchanger. In this embodiment, the core flow path heat exchanger 232 is arranged in the core flow path downstream of the combustor 210, and in some embodiments, downstream of the low pressure turbine 214. In this illustrative embodiment, the core flow path heat exchanger 232 is arranged downstream of the low pressure turbine 214 and at or proximate the core nozzle 216 upstream of the outlet 218. As the hydrogen fuel passes through the core flow path heat exchanger 232, the hydrogen fuel will pick up heat from the exhaust of the turbine engine system 200. As such, the temperature of the hydrogen fuel will be increased.

The heated hydrogen fuel may then be passed into an expansion turbine 234. As the hydrogen fuel passes through the expansion turbine 234 the hydrogen fuel will be expanded. The process of passing the hydrogen fuel through the expansion turbine 234 cools the hydrogen fuel and extracts useful power through the expansion process. Because the hydrogen fuel is heated from a cryogenic or liquid state in the hydrogen fuel tank 224 through the various mechanisms along the hydrogen fuel supply line 226, combustion efficiency may be improved.

Advantageously, embodiments of the present disclosure are directed to improved turbine engine systems that employ non-hydrocarbon fuels at cryogenic temperatures. In accordance with some embodiments, the systems described herein provide for a hydrogen-burning turbine engine that may allow the cryogenic fuel to recover heat from various systems such as waste heat-heat exchangers, system component heat exchangers, and expansion turbines. Accordingly, improved propulsion systems that burn hydrogen fuel and implement improved cooling schemes in both aircraft systems and engine systems are provided.

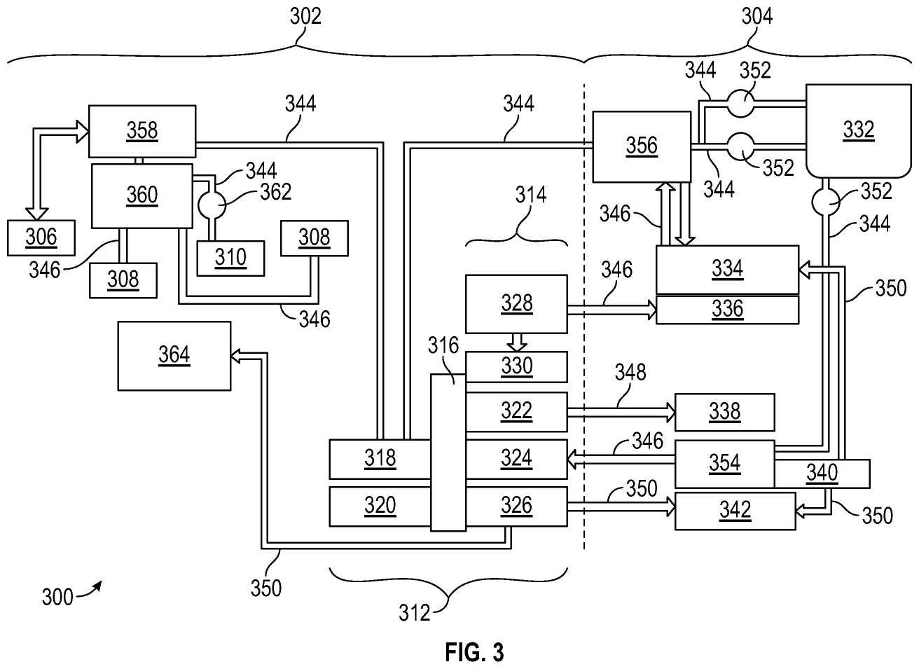

Referring now to FIG. 3, a schematic diagram of a turbine engine system 300 is shown. The turbine engine system 300 includes engine systems 302 and aircraft systems 304. In accordance with embodiments of the present disclosure, the engine systems 302 include components, devices, and systems that are part of an aircraft engine, which may be wing-mounted or fuselage-mounted and the aircraft systems 304 are components, devices, and systems that are located separately from the engine, and thus may be arranged within various locations on a wing, within a fuselage, or otherwise located onboard an aircraft.

The engine systems 302 may include the components shown and described above, including, without limitation, a fan section, a compressor section, a combustor section, a turbine section, and an exhaust section. In this schematic illustration, without limitation, the engine systems 302 include an engine oil system 306, an air cooling system 308, a burner 310 (e.g., part of a combustion section), a gear box system 312, and an anti-ice system 314. Those of skill in the art will appreciate that other systems, components, and devices may be incorporated into the engine system 302, and the illustrative embodiment is merely for explanatory and illustrative purposes. The gear box system 312, as shown, includes a main gear box 316 with various components operably connected thereto. In this illustrative embodiment, a hydrogen high pressure pump 318, an oil pump 320, a hydraulic pump 322, an air turbine starter 324, and a generator 326 may all be operably connected to the main gear box 316 of the gear box system 312. The anti-ice system 314 of the engine systems 302 includes an engine bleed system 328 that is configured to supply warm air to a cowl anti-ice system 330 to prevent ice build up on an engine cowl.

The aircraft systems 304 include various features installed and present that are separate from but may be operably or otherwise connected to one or more of the engine systems 302. In this illustrative, non-limiting configuration, the aircraft systems 304 include one or more hydrogen tanks 332 configured to store liquid hydrogen onboard the aircraft, such as in tanks that are wing-mounted or arranged within the aircraft fuselage. The aircraft systems 304 include a cabin air cooling system 334, a wing anti-ice system 336, flight controls 338, one or more generators 340, and aircraft power systems 342.

The schematic diagram in FIG. 3 of the turbine engine system 300 illustrates flow paths for different working fluids. For example, a hydrogen flow path 344 represents a flow path of liquid (or gaseous) hydrogen from the hydrogen tanks 332 to the burner 310. One or more air flow paths 346 represent airflow used for cooling and heat exchange with the hydrogen, and thus one or more heat exchangers or exchange systems may be provided to enable heat transfer from the air to the hydrogen, to cool the air and warm the hydrogen. A hydraulic fluid flow path 348 is illustrated fluidly connecting the hydraulic pump 322 to the flight controls 338. An electrical path 350 illustrates power generated by the generator 326 and distribution of such power (e.g., from generators 326, 340 to aircraft power systems 342 and other electrical systems onboard an aircraft). As shown, one or more of the paths 344, 346, 348, 350 may cross between the engine systems 302 and the aircraft systems 304.

Referring to the hydrogen flow path 344, liquid hydrogen may be sourced or supplied from the hydrogen tanks 332. One or more pumps 352 may be arranged to boost a pressure of the hydrogen as it is supplied from the hydrogen tanks 332. In some configurations, the pumps 352 may be low pressure pumps, providing an increase in pressure of about 20 psid to 50 psid, for example. The hydrogen may be supplied to one or more combustion systems. For example, a portion of the hydrogen may be supplied to an auxiliary power source 354, such as an auxiliary power unit having a dedicated burner or a fuel cell. The auxiliary power source 354 may be configured to direct air to the air turbine starter 324 along a leg of an air flow path 346. Further, this auxiliary power source 354 may be configured to generate power at the generator 340 to supply power to the aircraft power system 342 and/or the cabin air cooling system 334 and other ECS systems. In an embodiment, the auxiliary power source 354 is a thermal engine with a burner for combusting the hydrogen fuel to generate power. In another embodiment, the auxiliary power source 354 is connected to a generator to generate electric power onboard an aircraft.

For propulsion onboard the aircraft, a portion of the hydrogen may be supplied from the hydrogen tanks 332 along the hydrogen flow path 344 to a first heat exchanger 356 which may include a hydrogen-air heat exchanger to cool air. One or more low pressure pumps 352 may be arranged to boost a pressure and thus heat the hydrogen before entering the first heat exchanger 356. The first heat exchanger 356 may be part of an environmental control system (ECS) of the aircraft. The cooled air may be supplied, for example, to the cabin air cooling system 334. As this air is cooled, the hydrogen will be warmed within the first heat exchanger 356. The warmed hydrogen may then be passed through the hydrogen high pressure pump 318 which may further increase the pressure of the warmed hydrogen to maintain a pressure above a combustor pressure and/or above a critical pressure in order to avoid a phase change to gas in the plumbing, piping, flow path, or heat exchangers, for example.

The boosted pressure hydrogen may then be conveyed to a second heat exchanger 358. The second heat exchanger 358 may be a hydrogen-oil heat exchanger to cool engine oil of the engine systems 302. As such, the second heat exchanger 358 may be part of a closed loop of the engine oil system 306. In the second heat exchanger 358, the temperature of the hydrogen is further raised. Next, the hydrogen may be passed through a third heat exchanger 360. The third heat exchanger 360 may be a hydrogen-air heat exchanger. The third heat exchanger 360 may be part of an engine cooling system to supply air from one section of the engine systems 302 to another part of the engine systems 302 (e.g., from compressor section to turbine section, or from turbine section to compressor section). The cooled air generated in the third heat exchanger 360 may be used for cooling air (e.g., for a turbine) and/or for buffer air within compartments of the engine systems 302. The third heat exchanger 360 may thus use warm engine air for heating the hydrogen, but also cooling such air for air-cooling schemes of the engine systems 302. A valve 362 may be arranged to control a flow of the heated hydrogen into the burner 310. In some embodiments, and as shown, an electric compressor actuator 364 may be included within the engine systems 302. The electric compressor actuator 364 may be configured to boost a pressure of the hydrogen prior to injection into the burner 310.

Using the architecture illustrated in FIG. 3, and in accordance with embodiments of the present disclosure, the hydrogen may be used as a heat sink to provide increased cooling capacity as compared to other cooling schemes. For example, using liquid or supercritical hydrogen can, in some configurations, provide up to ten times the cooling capacity of prior systems. The hydrogen may be used at various locations along the hydrogen flow path 344 to provide cooling to one or more systems, as noted above. For example, the hydrogen can provide cooling to onboard electronics, generators, air for cooling purposes, etc. The pumps 318, 352 act to increase the temperature of the hydrogen. Use of low pressure pumps (e.g., pumps 352) can allow cooling of cooler heat sources (e.g., onboard electronics), whereas a high pressure pump (e.g., pump 318) can be used for higher heat sources (e.g., generators 326, 340). Further, because the hydrogen is low temperature at the first heat exchanger 356, the hydrogen may act as an efficient heat sink for air. As such, the cabin air conditioning system 334 and other aspects of onboard ECS can be reduced in size, weight, and complexity.

It will be appreciated that the turbine engine system 300 is an air breathing system. That is, the combustion of the hydrogen within the burner 310 is a mixture of pure hydrogen supplied from the hydrogen tanks 332 into the burner 310 where it is combusted in the presence of air pulled into the engine through a fan or the like. The turbine engine system 300 may be substantially similar in construction and arrangement to a hydrocarbon-burning system (e.g., conventional gas turbine engine) that burns, for example, jet fuel. The turbine of the turbine engine system 300 is thus driven by an output of the burner, similar to a conventional gas turbine engine. Because the turbine engine system 300 is an air-breathing system that relies upon combustion, a flow rate of the hydrogen into the burner 310, as controlled in part by the valve 362, may be relatively low (e.g., around 0.2 pounds per second at cruise or around 0.025 pounds per second at minimum idle).

Advantageously, a turbine engine system fueled by hydrogen allows for unique scaling of the engine core size and bypass ratios because the products of combustion from burning hydrogen have a higher specific heat and lower molecular weight in comparison to the combustion products of a conventional gas turbine engine burning conventional jet fuel. This unique scaling of the engine core size and bypass ratios help enable weight reductions in the hydrogen fueled turbine engine in comparison to its conventional jet fuel powered counterpart.

Referring now to FIGS. 2 and 3, the use of hydrogen allows the turbine engine system 200 of FIG. 2 and the turbine engine system 300 of FIG. 3 (herein referred to as hydrogen powered turbine engine system 200, 300) to increase the bypass ratio through reduction of engine core sizes. The bypass ratio is defined in the art as the ratio in an aircraft engine of the amount of airflow that is bypassed around the engine's core to the amount that passes through the core.

In an embodiment, the bypass ratio of the hydrogen powered turbine engine system 200, 300 may be between 5 to 24, 5 to 21, 5 to 20, 5 to 18, 5 to 15, 5 to 13, 5 to 12, 5 to 9, or other bypass ratios between 5 to 24, as will be appreciated by those of skill in the art. The bypass ratio may be at least 12, and less than 20, and may be about 13, in some embodiments.

In an embodiment, the core size of the hydrogen powered turbine engine system 200, 300 may be between about 0.68 to 2.04 kg/s (1.5 to 4.5 lbm/s). In an embodiment, the core size of the hydrogen powered turbine engine system 200, 300 may be equal to about 4.5 lbm/s (2.04 kg/s). The core sizes discussed throughout may be measured at max climb (MCL).

In an embodiment, the fan diameter of the fan (e.g., fan 204) of the hydrogen powered turbine engine system 200, 300 may be equal to about 2.16 meters (85 inches).

Advantageously, a turbine engine system fueled by hydrogen allows for a uniquely smaller ratio of the engine core size to the fan diameter ratio at MCL. The engine core size to fan diameter ratio at MCL may be between about 0.0177 to 0.0530 lbm/s in (0.00315 to 0.00946 kg/s cm). This uniquely smaller ratio of the engine core size to the fan diameter ratio at MCL help enable weight reductions in the hydrogen fueled turbine engine in comparison to its conventional jet fuel powered counterpart.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A turbine engine system, comprising:
aircraft systems comprising at least one hydrogen fuel tank;
engine systems comprising a compressor section, a combustor section having a burner, and a turbine section; and
a hydrogen fuel flow supply line configured to supply hydrogen fuel from the at least one hydrogen fuel tank into the burner for combustion,
wherein the turbine engine system has a bypass ratio of under 20 and above 12.

2. The turbine engine system of claim 1, wherein the bypass ratio is under 18 and above 12.

3. The turbine engine system of claim 1, wherein the bypass ratio is under 15 and above 12.

4. The turbine engine system of claim 1, wherein the bypass ratio is about 13.

5. The turbine engine system of claim 1, wherein the turbine engine system has a core size of size of 1.5 to 4.5 lbm/s.

6. The turbine engine system of claim 5, wherein the turbine engine system has a core size of size of 4.5 lbm/s.

7. The turbine engine system of claim 1, wherein the engine systems further comprise a fan, wherein the fan has a fan diameter of between 210 cm and 220 cm (82 inches to 86 inches).

8. The turbine engine system of claim 1, wherein the engine systems further comprise a fan, wherein an engine core size to fan diameter ratio at max climb is between 0.003 and 0.010 kg/s·cm (between 0.017 and 0.053 lbm/sin).

9. The turbine engine system of claim 1, wherein the aircraft systems further comprise a first heat exchanger,
wherein the engine systems further comprise at least a second heat exchanger and a third heat exchanger, and
wherein the hydrogen fuel is supplied from the at least one hydrogen fuel tank through the hydrogen fuel flow supply line, passing through the first heat exchanger of the aircraft systems, the second heat exchanger of the engine systems, and the third heat exchanger of the engine systems, and then supplied into the burner for combustion.

10. The turbine engine system of claim 9, wherein the first heat exchanger is a hydrogen fuel-to-air heat exchanger.

11. The turbine engine system of claim 9, wherein the first heat exchanger is part of a cabin air conditioning system of an aircraft.

12. The turbine engine system of claim 9, wherein the second heat exchanger is a hydrogen fuel-to-oil heat exchanger.

13. The turbine engine system of claim 9, wherein the third heat exchanger is a hydrogen fuel-to-air heat exchanger.

14. The turbine engine system of claim 9, wherein the aircraft systems include an auxiliary power source configured to receive the hydrogen fuel from the at least one hydrogen fuel tank to generate power.

15. The turbine engine system of claim 14, wherein the auxiliary power source is a fuel cell.

16. The turbine engine system of claim 14, wherein the auxiliary power source is a thermal engine with a burner for combusting the hydrogen fuel to generate power.

17. The turbine engine system of claim 14, wherein the auxiliary power source is connected to a generator to generate electric power onboard an aircraft.

18. The turbine engine system of claim 10, further comprising at least one pump arranged along the hydrogen fuel flow supply line between the at least one hydrogen fuel tank and the first heat exchanger.

19. The turbine engine system of claim 10, further comprising a valve arranged along the hydrogen fuel flow supply line between the third heat exchanger and the burner, the valve configured to control a flow of the hydrogen fuel into the burner.
